(19) United States
(12) Patent Application Publication
(10) Pub. No.: US 2009/0205962 A1
(43) Pub. Date: Aug. 20, 2009

(54) Electrophoresis device and method

(75) Inventors: R. Lloyd Carroll, Morgantown, WV (US); Aaron T. Timperman, Morgantown, WV (US); Boyd F. Edwards, Westover, WV (US)

Correspondence Address: SPILMAN THOMAS & BATTLE PLLC;C/O CPA Global, P.O. BOX 52050, MINNEAPOLIS, MN, 55402, US

(73) Assignee: West Virginia University

(21) Appl. No.: 11/827,245

(22) Filed: Jul. 11, 2007

(51) Int. Cl. B01D 57/02

(52) U.S. Cl. 204/547; 204/643

(57) ABSTRACT

A continuous periodic electric wave electrophoresis device and method generates a continuous periodic electric wave that electrophoretically separates charged particles within a sample. The device can have a channel wherein the sample is introduced. At least three interdigitated arrays of conducting electrodes can be positioned adjacent the channel with each array having an externally controllable electrical potential. An externally controlled electric current can be applied to each array of conducting electrodes, creating a continuous periodic electric wave having a selectable wave speed within the channel that separates the particles within the sample. The continuous periodic electric wave can entrain high-mobility particles and immobilize low-mobility particles.

### BACKGROUND

An electrophoresis device and method as described herein relates generally to the separation of particles based on their electric charge, molecular weight and electrophoretic mobility through a process of electrophoresis utilizing a continuous periodic electric wave.

The separation of charged particles through the use of electrophoresis is well known in the art. See, for example, U.S. Pat. Nos. 4,900,414 (Sibalis) entitled “Commercial Separation System And Method Using Electrokinetic Techniques;” 7,118,661 (Surh et al.) entitled “Nanolaminate Microfluidic Device For Mobility Selection Of Particles;” U.S. Patent Application Publication No. US2004/0265992 A1 (Matsuda et al.) entitled “Microchemical Chip and Method For Producing The Same;” and Japanese Patent Application Publication No. 2005291870A (Takao) entitled “Microchannel Module.”

### SUMMARY

The electrophoresis device and method described can utilize a continuous periodic electric wave to separate charged particles in a sample. An embodiment of the electrophoresis device can generally comprise a top surface, a bottom surface, a pair of spaced apart spacers disposed between the top surface and bottom surface that define a channel therebetween, and at least three interdigitated arrays of conducting electrodes positioned adjacent the channel. The top surface, bottom surface, and spacers can be made from a non-electrically conducting material. The size of the channel can be defined by the width and height of the spacers. Each interdigitated array of conducting electrodes can be adapted for connection to a controllable source of electricity in order to create a continuous periodic electric wave within the channel. Each interdigitated array of conducting electrodes can have an individually controllable electric potential. Each electric potential can be individually controllable to create the continuous periodic electric wave having a selected frequency, wavelength and wave speed traveling in a specified direction within the channel. In one embodiment, two interdigitated arrays of conducting electrodes can be positioned adjacent one side of the channel and another two interdigitated arrays of conducting electrodes can be positioned adjacent an opposite side of the channel.

In general, a sample containing charged particles can be introduced to the channel and electricity can be applied to the interdigitated arrays of conducting electrodes in order to electrophoretically separate the particles within the sample in a manner described in more detail hereinafter. More particularly, each of the electric potentials can be individually controlled to create a continuous periodic electric wave having a selected frequency, wavelength and wave speed traveling in a specified direction within the channel. Particles having different electric charge, molecular weight, and electrophoretic mobility can have different electrophoretic velocities in response to electric fields, and can achieve different average velocities through the channel in response to the continuous periodic electric wave. High-mobility particles having average electrophoretic velocities substantially greater than or equal to the wave speed can be entrained by the continuous periodic electric wave. The continuous periodic electric wave can also selectively immobilize other low-mobility particles that have average electrophoretic velocities less than the wave speed. In another embodiment, the electrophoresis device can be used as a component of a multidimensional separation device having a plurality of side channels and a plurality of at least three interdigitated arrays of conducting electrodes wherein particles of different electrophoretic velocities can be separated into different side channels in a similar manner as described above.

In another embodiment, the electrophoresis device can comprise a channel provided through a block of material. The block can be made from a non-electrically conducting material. The channel can have at least three interdigitated arrays of conducting electrodes positioned adjacent the channel in a similar manner as described above. Each interdigitated array of conducting electrodes can have individually controllable electric potentials. Each interdigitated array of conducting electrodes can be adapted for connection to controllable sources of electricity in order to create a continuous periodic electric wave within the channel. In one embodiment, the channel can be generally cylindrical in shape and the interdigitated arrays of conducting electrodes can be arcuate shaped. Each of the electric potentials can be individually controlled in order to create a continuous periodic electric wave having a selected frequency, wavelength, and wave speed traveling in a specified direction within the channel that can entrain high-mobility particles and immobilize low-mobility particles.

An embodiment of an electrophoresis method as described herein can generally comprise providing a sample containing charged particles to be separated through a channel and creating a continuous periodic electric wave within the channel in a manner such that particles of a high-mobility can be entrained and particles of a low-mobility can be immobilized. The frequency, wavelength, wave speed, and direction of the continuous periodic electric wave can be manipulated via the individually controllable electric potentials of the interdigitated arrays of conducting electrodes. The dispersion of particles that do not have electrophoretic velocities substantially greater than or equal to the wave speed can be suppressed.

Other advantages and features of the electrophoresis device and method may become apparent from the following detailed description, when considered in conjunction with the appended drawing figures.

### BRIEF DESCRIPTION OF THE DRAWING FIGURES

A more complete understanding of the electrophoresis device and method can be obtained by considering the following description in conjunction with the accompanying drawings, in which:

FIG. 1A is an exploded view of an embodiment of an electrophoresis device;

FIG. 1B is a plan view of an embodiment of an electrophoresis device;

FIG. 2 is an exploded cross sectional view of another embodiment of an electrophoresis device;

FIG. 3 is an exploded view of an embodiment of an electrophoresis device;

FIG. 4A is a plan view of an embodiment of an electrophoresis device; and

FIG. 4B is an exploded view of an embodiment of an electrophoresis device.

### DETAILED DESCRIPTION OF CERTAIN EMBODIMENTS

The controlled application of electricity to at least three interdigitated arrays of conducting electrodes positioned adjacent a channel containing a sample of charged particles can create a continuous periodic electric wave having a selected frequency, wavelength, and wave speed traveling in a specified direction within the channel that can separate particles that have different electrophoretic velocities. Separation occurs because particles having different electrophoretic velocities move through the channel at different average velocities. High-mobility particles are particles having a high ratio of electrophoretic velocity to wave speed and low-mobility particles are particles having a low ratio of electrophoretic velocity to wave speed. High-mobility particles can be entrained by the continuous periodic electric wave. The continuous periodic electric wave can also selectively immobilize low-mobility particles.

The sample containing particles to be separated can comprise fully functional and non-denatured proteins, a buffer solution and/or a detergent. A variety of common solvents can be used to dissolve the particles to be separated, including, but not limited to, water, organic solvents, such as methanol or acetonitrile, gases, and supercritical fluids. The continuous periodic electric wave electrophoresis device and method are not limited to the microfluidic environment discussed herein, but can also be applied to much larger and/or smaller devices; and can be utilized with charged particles ranging in size from the smallest ions, to proteins, organelles, cells, or particles of matter. The continuous periodic electric wave electrophoresis device can also be used as a component of a multidimensional separation device in which particles of different electrophoretic velocities can be separated into different side channels.

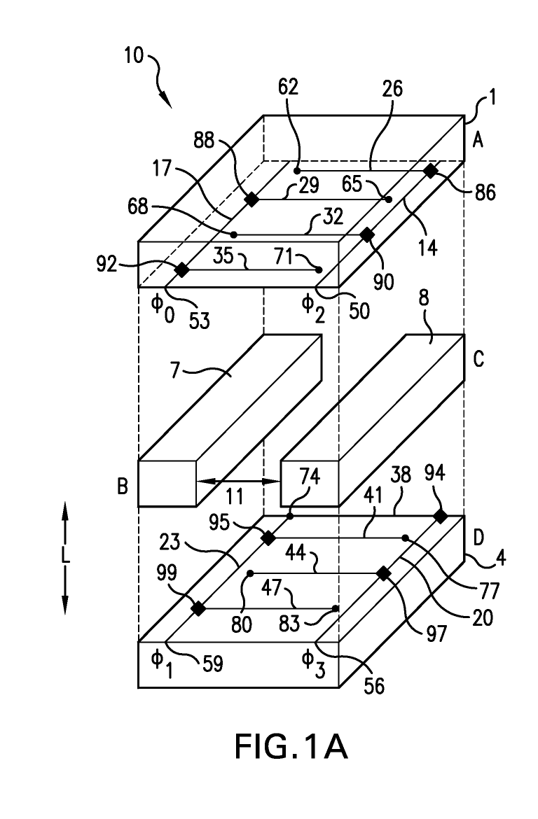

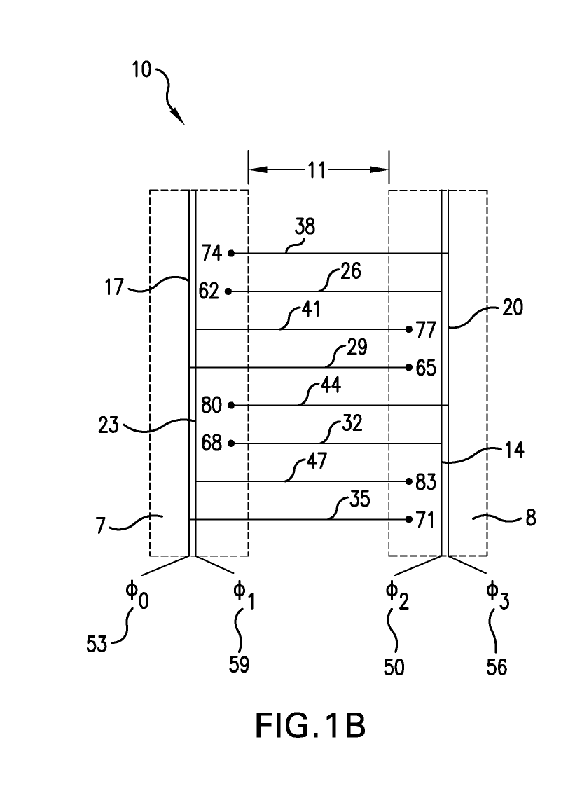

Referring now to the drawing figures, wherein like reference numerals are used to refer to like elements throughout, an exploded view of an embodiment of an continuous periodic electric wave electrophoresis device 10 is illustrated in FIG. 1A, which can generally comprise a top surface 1, a bottom surface 4, and a pair of spaced apart spacers 7, 8 disposed between the top 1 and bottom 4 surfaces which define a channel 11 therebetween. The size of channel 11 can be determined by the width and height of spacers 7, 8. The top 1 and bottom 4 surfaces can be made from electrically insulating materials or non-electrically conducting materials, for example, but not limited to, glass and silicon coated with an oxide layer, which can dissipate heat generated by the electrophoresis device 10.

The electrophoresis device 10 can further comprise interdigitated arrays of conducting electrodes 14, 17, 20, 23 positioned adjacent opposite sides of channel 11. The interdigitated arrays of conducting electrodes 14, 17, 20, 23 can be arranged perpendicular to the longitudinal axis L of channel 11. Each interdigitated array of conducting electrodes 14, 17, 20, 23 can comprise a trunk connected to multiple electrode arms, such as electrode arms 26 and 32 for interdigitated array 14, electrode arms 29 and 35 for interdigitated array 17, electrode arms 38 and 44 for interdigitated array 20, and electrode arms 41 and 47 for interdigitated array 23, in such a way that the trunk and electrode arms for a particular interdigitated array share a common electrical potential. In alternative embodiments, each trunk can have hundreds or thousands of electrode arms. Electrode arms 26, 29, 32, 35, 38, 41, 44, 47 can be positioned on the inner surface of channel 11 so as to be in contact with the sample during the electrophoretic separation process. Electrode arms 26, 29, 32, 35, 38, 41, 44, 47 can be rectangular or cylindrical, and can be made of electrically conducting materials, such as, for example, gold or palladium.

Each interdigitated array of conducting electrodes 14, 17, 20, 23 can further comprise controllable electric potentials 50, 53, 56, 59. Each interdigitated array of conducting electrodes 14, 17, 20, 23 can be adapted for connection to externally controllable sources of electricity in order to create a continuous periodic electric wave within channel 11 through the use of electric potentials 50, 53, 56, 59. The electric potentials 50, 53, 56, 59 can appear within each wavelength of the spatially periodic electrode pattern. Each electric potential 50, 53, 56, 59 can be individually controlled in order to create a continuous periodic electric wave having a selected frequency, wavelength, and wave speed traveling in a specified direction within channel 11.

The period of one wave can be sinusoidal, square, triangular or any shape that is desired for a particular application. For example, electric potentials 50, 53, 56, 59 can be controlled to generate sinusoidal waves with a given angular frequency that share the same amplitude and frequency, but differ in phase. Each electric potential 50, 53, 56, 59 can be individually controlled in order to vary the concentration effects of the electrophoretic separation process. The manipulation of the continuous periodic electric wave provides for a variety of concentration and control effects that can be performed on a sample, including dispersion-free transport. The electric potentials 50, 53, 56, 59 can also be time dependent based on the position of electrode arms 26, 29, 32, 35, 38, 41, 44, 47.

A plan view of an embodiment of the continuous periodic electric wave device 10 is illustrated in FIG. 1B, in which electrode arms 26, 29, 32, 35 on top surface 1 are interleaving electrode arms 38, 41, 44, 47 on bottom surface 4. The arrays of conducting electrodes 14, 17, 20, 23 can overlap, i.e., interdigitate, in such a way that the wavelength of the electrophoresis device 10 can be defined by the distance between adjacent electrode arms extending from a common trunk at the same electric potential 50, 53, 56, 59. For example, the wavelength of the electrophoresis device 10 can be defined as the distance between electrode arms 26 and 32, or 29 and 35, or 38 and 44, or 41 and 47. The distance between adjacent electrode arms 26, 29, 32, 35, 38, 41, 44, 47 must be small enough to avoid high-field electrochemical reactions and large electric potentials. Metal contacts at electric potentials 50, 53, 56, 59 can be evenly and periodically spaced along the longitudinal axis L of channel 11.

The creation of the continuous periodic electric wave can be based upon the amplitude of the current drawn by each electrode arm 26, 29, 32, 35, 38, 41, 44, 47 of the interdigitated arrays of conducting electrodes 14, 17, 20, 23. The chemical reactions and molecular diffusion at electrode arms 26, 29, 32, 35, 38, 41, 44, 47 can keep pace with the current flowing into each electrode arm 26, 29, 32, 35, 38, 41, 44, 47 such that each electrode arm 26, 29, 32, 35, 38, 41, 44, 47 can draw a current. The current can be generated by the flow of buffer particles toward and away from electrode arms 26, 29, 32, 35, 38, 41, 44, 47. The current can be spatially non-uniform, and can increase from zero at the end of the electrode arms 62, 65, 68, 71, 74, 77, 80, 83 to a value that can be based on where electrode arms 26, 29, 32, 35, 38, 41, 44, 47 leave channel 11 toward the trunk 86, 88, 90, 92, 94, 95, 97, 99 of the associated interdigitated array of conducting electrodes 14, 17, 20, 23. The current can vary in a similar manner as when electrode potentials 50, 53, 56, 59 generate waves that are sinusoidal, square, triangular, or any other shape that is desired.

A sample containing charged particles to be separated can be passed through channel 11 and electricity can be applied to the interdigitated arrays of conducting electrodes 14, 17, 20, 23 to electrophoretically separate the particles within the sample. Each electric potential 50, 53, 56, 59 can be individually controlled to create a continuous periodic electric wave having a selected frequency, wavelength, and wave speed traveling in a specified direction within channel 11 such that high-mobility particles within the sample are entrained by the continuous periodic electric wave. As explained above, the continuous periodic electric wave can, at the same time, immobilize low-mobility particles within the sample.

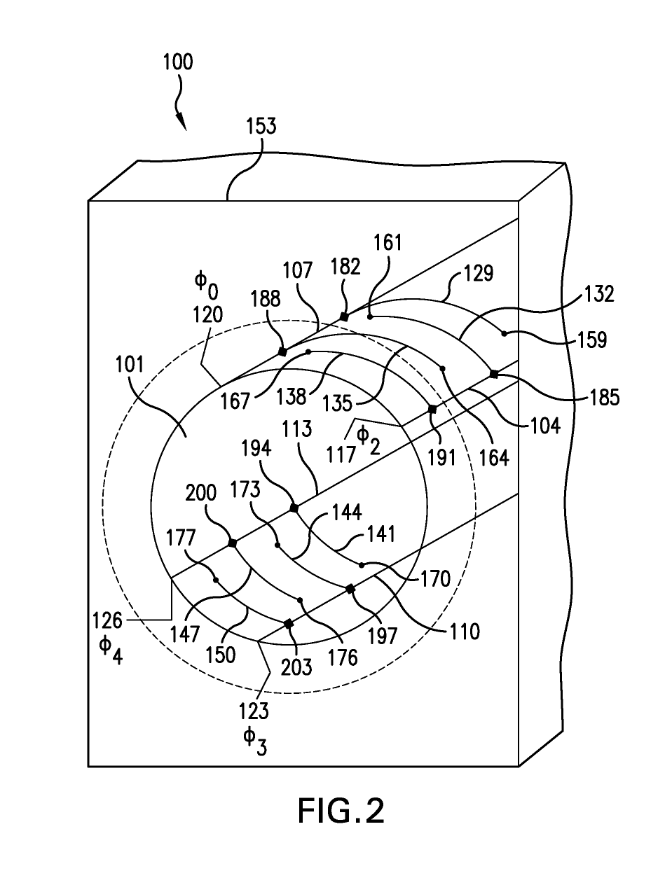

A further embodiment of an electrophoresis device 100 is illustrated in FIG. 2. In this embodiment, the electrophoresis device 100 can comprise a channel 101 provided through a block 153. The block 153 can be made from a substantially non-electrically conducting material, for example, but not limited to, glass and silicon coated with an oxide layer, which can dissipate heat generated by the electrophoresis device 100 that might otherwise cause the electrophoresis device 100 to malfunction. The electrophoresis device 100 can further comprise a plurality of interdigitated arrays of conducting electrodes 104, 107, 110, 113 positioned adjacent channel 101 so as to be in contact with the sample during the electrophoretic separation process. Channel 101 can be generally cylindrical in shape and the interdigitated arrays of conducting electrodes 104, 107, 110, 113 can be arcuate shaped.

Each interdigitated array of conducting electrodes 104, 107, 110, 113 can comprise a trunk having multiple electrode arms, such as electrode arms 129, 132, 135, 138, 141, 144, 147, 150, connected to a common electric potential 117, 120, 123, 126. The electrode arms 129, 132, 135, 138, 141, 144, 147, 150 can be rectangular or cylindrical, and can be made of electrically conducting materials, such as, for example, gold or palladium. Each interdigitated array of conducting electrodes 104, 107, 110, 113 can be adapted for connection to externally controllable sources of electricity in order to create a continuous periodic electric wave having a selected frequency, wavelength, and wave speed traveling in a specified direction within channel 101. The electric potentials 117, 120, 123, 126 can appear within each wavelength of the spatially periodic electrode pattern. Each electric potential 117, 120, 123, 126 can be individually controlled to generate a continuous periodic electric wave having a selected frequency, wavelength, and wave speed traveling in a specified direction within channel 101.

The interdigitated arrays of conducting electrodes 104, 107, 110, 113 can overlap, i.e., interdigitate, in such a way that the wavelength of the electrophoresis device 100 can be defined by the distance between adjacent electrode arms extending from a common trunk at the same electric potential, e.g., the distance between electrode potentials 129 and 135, or 132 and 138, or 141 and 147, or 144 and 150. The metal contacts at electric potentials 117, 120, 123, 126 can be evenly and periodically spaced along channel 101.

The period of one wave can be sinusoidal, square, triangular, or any shape that is desired for a particular application. For example, electric potentials 117, 120, 123, 126 can be controlled to generate sinusoidal waves with a given angular frequency that share the same amplitude and frequency, but differ in phase. Each electric potential 117, 120, 123, 126 can be individually controllable in order to vary the concentration effects of the electrophoretic separation process. The manipulation of the continuous periodic electric wave provides for a variety of concentration and control effects that can be performed on a sample, including dispersion-free transport. Electric potentials 117, 120, 123, 126 can be time dependent based on the position of electrode arms 129, 132, 135, 138, 141, 144, 147, 150.

The creation of the continuous periodic electric wave can be based upon the amplitude of the current drawn by each electrode arm 129, 132, 135, 138, 141, 144, 147, 150 of the interdigitated arrays of conducting electrodes 104, 107, 110, 113. The chemical reactions and molecular diffusion at electrode arms 129, 132, 135, 138, 141, 144, 147, 150 can keep pace with the current flowing into each electrode arm 129, 132, 135, 138, 141, 144, 147, 150 such that each electrode arm 129, 132, 135, 138, 141, 144, 147, 150 can draw a current. The current can be generated by the flow of buffer particles toward and away from electrode arms 129, 132, 135, 138, 141, 144, 147, 150. The current can be spatially non-uniform, and can increase from zero at the end of the electrode arms 158, 161, 164, 167, 170, 173, 176, 179 to a value that can be based on where electrode arms 129, 132, 135, 138, 141, 144, 147, 150 leave channel 101 toward the trunk 182, 185, 188, 191, 194, 197, 200, 203 of the associated interdigitated array of conducting electrodes 104, 107, 110, 113. The current can vary in a similar manner as electrode potentials 117, 120, 123, 126.

A sample containing charged particles to be separated can be passed through channel 101 and electricity can be applied to the interdigitated arrays of conducting electrodes 104, 107, 110, 113 in order to electrophoretically separate the particles within the sample. The interdigitated arrays of conducting electrodes 104, 107, 110, 113 can be positioned adjacent channel 101 so as to be in contact with the sample during the electrophoretic separation process. Each electric potential 117, 120, 123, 126 can be individually controlled to create a continuous periodic electric wave having a selected frequency, wavelength, and wave speed traveling through channel 101 that can entrain high-mobility particles within the sample. As explained previously, the continuous periodic electric wave can, at the same time, immobilize low-mobility particles within the sample. The embodiment 100 depicted in FIG. 2 can generally work in a similar manner as described previously in connection with embodiment 10 depicted in FIG. 1A.

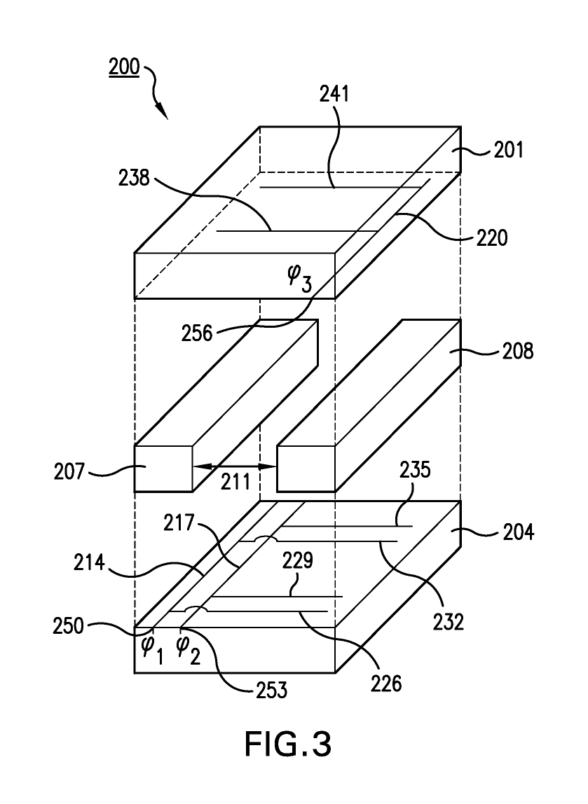

A further embodiment of an electrophoresis device 200 is illustrated in FIG. 3, which can generally comprise a top surface 201, a bottom surface 204, and a pair of spaced apart spacers 207, 208 disposed between the top 201 and bottom 204 surfaces which define a channel 211 therebetween. The size of channel 211 can be determined by the width and height of spacers 207, 208. The top 201 and bottom 204 surfaces can be made from electrically insulating materials, for example, but not limited to, glass and silicon coated with an oxide layer.

The device 200 can further comprise two interdigitated arrays of conducting electrodes 214, 217 positioned on the same side of channel 211 on bottom surface 204 and another interdigitated array of conducting electrodes 220 positioned on an opposite side of channel 211 on top surface 201. The interdigitated arrays of conducting electrodes 214, 217, 220 can be arranged perpendicular to the longitudinal axis L of channel 211. Each interdigitated array of conducting electrodes 214, 217, 220 can comprise multiple electrode arms, such as electrode arms 226, 229, 232, 235, 238, 241, which can be positioned adjacent channel 211 so as to be in contact with the sample during the electrophoretic separation process. The electrode arms 226, 232 of interdigitated array of conducting electrode 214 must avoid electrical contact with the trunk of interdigitated array of conducting electrode 217. The electrode arms 226, 229, 232, 235, 238, 241 can be rectangular or cylindrical, and can be made of electrically conducting materials, such as, for example, gold or palladium.

Each interdigitated array of conducting electrodes 214, 217, 220 can further comprise externally controllable electric potentials 250, 253, 256. Each interdigitated array of conducting electrodes 214, 217, 220 can be adapted for connection to externally controllable sources of electricity in order to create a continuous periodic electric wave having a selected frequency, wavelength, and wave speed traveling in a specified direction within channel 211 through the use of electric potentials 250, 253, 256. Each of the interdigitated arrays of conducting electrodes 214, 217, 220 depicted in FIG. 3 can be individually controlled to separate charged particles within the sample generally in a similar manner as described previously in connection with embodiment 10 depicted in FIG. 1A.

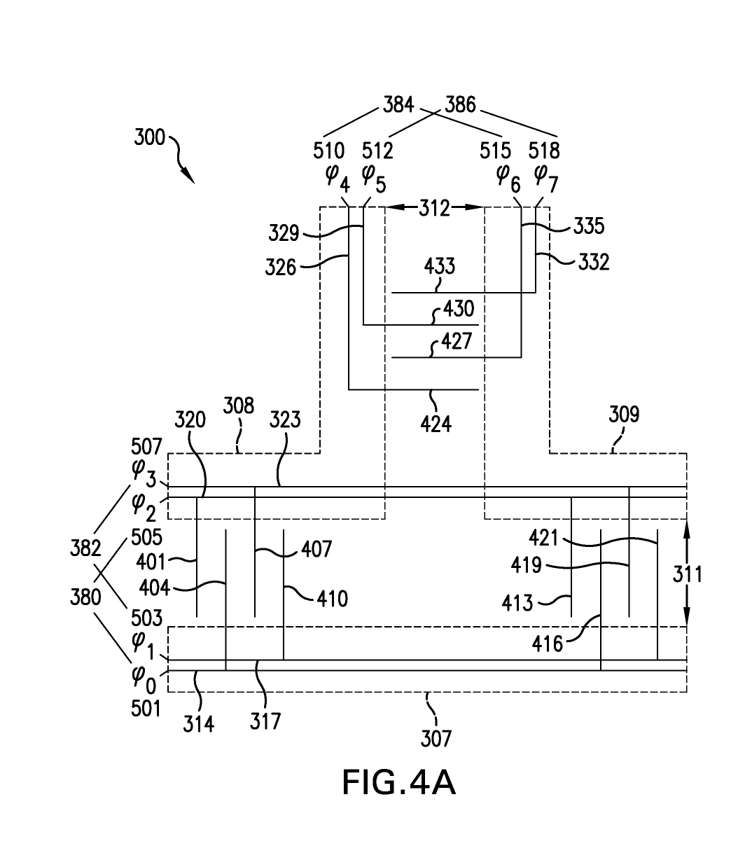

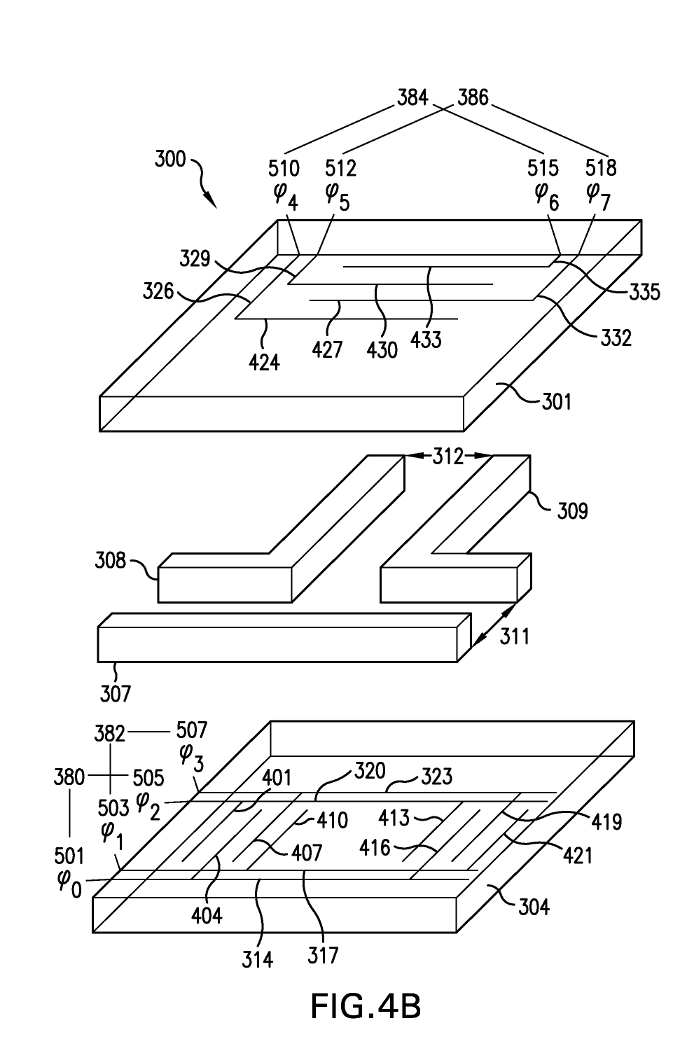

A further embodiment of an electrophoresis device 300 is illustrated in FIGS. 4A and 4B. In this embodiment, a multidimensional electrophoresis separation device 300 can generally comprise a top surface 301, a bottom surface 304, and a plurality of spacers 307, 308, 309 arranged in the form of a two-dimensional matrix defining a primary channel 311 and one or more secondary channels 312. The sizes of channels 311, 312 can be determined by the width and height of spacers 307, 308, 309. The device can further comprise a plurality of sets 380, 382, 384, 386 of at least three interdigitated arrays of conducting electrodes 314, 317, 320, 323, 326, 329, 332, 335 positioned adjacent channels 311, 312, respectfully.

The interdigitated arrays of conducting electrodes 314, 317, 320, 323, 326, 329, 332, 335, can comprise multiple electrode arms, such as electrode arms 401, 404, 407, 410, 413, 416, 419, 421, 424, 427, 430, 433, which can be perpendicularly positioned on the inner surface of channels 311, 312, respectfully, so as to be in contact with the sample during the electrophoretic separation process. Each interdigitated array of conducting electrodes 314, 317, 320, 323, 329, 326, 332, 335 can further comprise externally controllable electric potentials 501, 503, 505, 507, 510, 512, 515, 518. Each interdigitated array of conducting electrodes 314, 317, 320, 323, 329, 326, 332, 335 can be adapted for connection to externally controllable sources of electricity to create continuous periodic electric waves having a selected frequency, wavelength, and wave speed traveling in a specified direction within each channel 311, 312 through the use of the electric potentials 501, 503, 505, 507, 510, 512, 515, 518. Each interdigitated arrays of conducting electrodes 314, 317, 320, 323, 329, 326, 332, 335 can be individually controlled.

The multidimensional electrophoresis separation device 300 can separate charged particles within a sample generally in a similar manner as described previously in connection with embodiment 10 depicted in FIG. 1A, except that particles with different electrophoretic velocities can be separated into different side channels. A sample containing charged particles to be separated can be introduced to channel 311 and electricity can be applied to the interdigitated arrays of conducting electrodes 314, 317, 320, 323 to electrophoretically separate the particles within channel 311. Electricity can then stop being applied to the interdigitated arrays of conducting electrodes 314, 317, 320, 323 and electricity can be applied to the interdigitated arrays of conducting electrodes 326, 329, 332, 335 to electrophoretically separate particles within channel 312.

An embodiment of an electrophoresis method as described herein can comprise providing a sample containing charged particles to be separated through a channel and creating a continuous periodic electric wave within the channel such that high-mobility particles can be entrained and low-mobility particles can be immobilized. The frequency, wavelength, wave speed, and direction of the continuous periodic electric wave within the channel can be controlled such that the dispersion of particles that do not have electrophoretic velocities substantially greater than or equal to the wave speed can be suppressed by the continuous periodic electric wave.

The electrophoresis method can further comprise imposing a pressure driven flow or an electro-osmotic flow in order to enhance the effects of the continuous periodic electric wave. Furthermore, the electro-osmotic flow of the electrophoretic separation process can be suppressed by using oscillating electric fields.

Generally, ohmic losses during the electrophoretic separation process can heat the electrolytic solution in channel 11 and the surrounding non-electrically conducting surfaces 1, 4, 7, 8. This heating can be most pronounced in the electrode segments between channel 11 and the trunks of the interdigitated arrays of conducting electrodes 14, 17, 20, 23 because these segments can carry the full current load of channel 11. In an embodiment of the electrophoresis device 10, where an electrode segment of length L, Area A=2 μm×200 nm, and resistivity ρ can have a resistance R=ρL/A, and can dissipate an average power of P=I²R/2 in which I²/2 can be the mean square current through the electrode segment. This electrode segment can heat a nearby volume V=LHλ/2 of glass, where the glass plate thickness H=1 mm. The average heat Q=mcₚΔT=PΔt added to this volume of glass during a time Δt can involve its mass m=ρₘV, where the specific heat cₚ=840 J/kg−K and the mass density of glass ρₘ=2600 kg/m³. The small contribution supplied by the relatively thin spacers 7, 8 having a height of about 10 μm to about 20 μm between the glass plates 1, 4 can be ignored.

Where the electrophoresis device 10 is assumed to be thermally insulated from its surroundings, the rate at which the electrophoresis device 10 temperature rises at the junction region where electrode arms 26, 29, 32, 35, 38, 41, 44, 47 meet the trunk of each interdigitated arrays of conducting electrodes 14, 17, 20, 23 can be given by the equation:

$$\frac{Δ T}{Δ t} = \frac{ρ {I}^{2}}{{ρ}_{m} H {λ AC}_{p}}$$

Using the parameter values listed above, ΔT/Δt=7.4×10⁻⁴ K/s, which can amount to a temperature rise of 1 K after twenty two minutes of operating the electrophoresis device 10. A wave with f=6 Hz and λ=80 μm propagating at speed c=fλ=0.48 mm/s can require sixty two and a half seconds to travel a distance of three centimeters (which can involve three hundred and seventy five wavelengths of the electrode pattern).

In an embodiment of the electrophoresis device 10 where the non-electrically conducting surfaces 1, 4 comprise glass, the heat produced by electrode arms 26, 29, 32, 35, 38, 41, 44, 47 can quickly dissipate into glass surfaces 1, 4, which can prevent electrode arms 26, 29, 32, 35, 38, 41, 44, 47 from melting or becoming detached from glass surfaces 1, 4. The thermal diffusivity κ=k/ρₘcₚ of glass can rely on its thermal conductivity, k=0.8 W/m−K, and can govern the time scale H²/κ=2.7 s that can be required for heat diffusion through a glass plate having a thickness H, indicating that the heat produced by the electrode arms 26, 29, 32, 35, 38, 41, 44, 47 can quickly diffuse into glass surfaces 1, 4. Where φ(t) has an amplitude Φ, the electric potential can change by this amount each quarter wavelength of the electrode pattern, and the electric field can scale as E=4Φ/λ=400 V/cm. Since electrode arms 26, 29, 32, 35, 38, 41, 44, 47 can reside on the top and bottom boundaries of channel 11, the electric fields within channel 11 can be generally less than this value.

In an embodiment of the electrophoresis device 10 where the resistance of electrode arms 26, 29, 32, 35, 38, 41, 44, 47 of the length w=100 μm and resistivity (for gold) ρ=2.44×10⁻⁸ Ω·m can be R=ρw/A=6.1 Ω, the amplitude of the potential difference across this length can be ΔΦ=IR=0.28 mV. Since this potential difference can be small compared with the applied potential amplitude, Φ=0.8V, electrodes made of gold can be considered as equipotential surfaces.

The electric potentials 50, 53, 56, 59 can be used to approximate a continuous periodic electric wave of frequency f; wavelength λ, and speed c=fλ traveling in the ±x direction within channel 11 according to the equation:

Φᵢ(t)=g(x_{i∓ct}),

where xᵢ=fλ/4 can be the positions of electrode arms 26, 29, 32, 35, 38, 41, 44, 47 for electric potentials 50, 53, 56, 59. The function g(ξ), defined for 0≦ξ≦λ, can describe the shape of one period of the wave, which can be sinusoidal g(ξ)=Φ sin (2πξ/λ), square, triangular or any shape that is desired for a particular application. For example, electric potentials 50, 53, 56, 59 can generate sinusoidal waves with an angular frequency ω=2πf that share the same amplitude Φ and angular frequency ω, but can differ in phase according to the following equation:

Φᵢ(t)=Φ sin (iπ/2∓ωt)

The creation of the continuous periodic electric wave can be based upon an estimation of the amplitude of the current drawn by each electrode arm 26, 29, 32, 35, 38, 41, 44, 47, which can require the electric field amplitude at the electrode surface. For an electrode radius a<<λ, a single term can dominate the infinite sum of the corresponding electric field when it is evaluated at electrode arms 26, 29, 32, 35, 38, 41, 44, 47. This term gives the electric field amplitude just outside the surfaces of electrode arms 26, 29, 32, 35, 38, 41, 44, 47:

$$E = \frac{Φ}{a ln ( λ / 2 a )}$$

Assuming faradaic processes at electrode arms 26, 29, 32, 35, 38, 41, 44, 47, the chemical reactions and molecular diffusion at electrode arms 26, 29, 32, 35, 38, 41, 44, 47 can keep pace with the current flowing towards and away from each electrode arm 26, 29, 32, 35, 38, 41, 44, 47, and can cause each electrode arm 26, 29, 32, 35, 38, 41, 44, 47 to draw a current, wherein:

I=nqvA.

in which A=2πaw can be the (cylindrical) surface area of electrode arms 26, 29, 32, 35, 38, 41, 44, 47 along the width w of channel 11, n can be the number density of the buffer species that carries the bulk of the current, q can be the charge of each charge carrier, and v=|μ|E can be the amplitude of the electrophoretic speed. Using these results and the molar concentration c=n/Nₐ, the following equation can be obtained for the amplitude of the current drawn from each electrode arm 26, 29, 32, 35, 38, 41, 44, 47:

$$I = \frac{2 π {cN}_{a} q \vert μ \vert w Φ}{ln ( λ / 2 a )} .$$

The electrode current can vary sinusoidally between the values −I and I, just as the electrode potential can vary sinusoidally between the value −Φ and Φ. Because this current can be generated by the radial flow of buffer particles towards and away from electrode arms 26, 29, 32, 35, 38, 41, 44, 47, the electrode current can be spatially non-uniform and can increase from zero at the end of electrode arms 62, 65, 68, 71, 74, 77, 80, 83 to a value given by the previous equation where electrode arms 62, 65, 68, 71, 74, 77, 80, 83 leave channel 11 on their way to the trunk of the interdigitated arrays of conducting electrodes 14, 17, 20, 23. Using a concentration of c=50 mM, Nₐ=6.02×10²³/mole, q=1.6×10⁻¹⁹C, μ=0.7 cm²/kV·s (for a typical KCl buffer), w=100 μm, Φ=0.8V, λ=80 μm, and a=1 μm, the value of I=46 μA can be obtained. The estimated solution resistance Rₛ=35 kΩ between two electrodes follows from Ohm's law, 2ΦIRₛ.

A difference in the size of channel 11 can have an effect on the continuous periodic electric wave electrophoresis method. For example, in long and wide channels, the electric potentials 50, 53, 56, 59 and the electric field can have simple closed-form mathematical representations when the function g(ξ) is odd about the midpoint ξ=λ/2, that is when g(ξ−λ/2)=−g(ξ), a property that can be satisfied by sinusoidal, square and triangular waves. When x₂−x₀=x₃−x₁=λ/2, the electric potentials 50, 53, 56, 59 for waves that are odd about their midpoints can satisfy Φ₂=−Φ₀ and Φ₃=−Φ₁. Accordingly, the potential Φ produced by electrodes Φ₀ 53 and Φ₂ 50 and at a point separated by distances ρ₀ and ρ₂ from the centers of these electrodes can be:

$$φ = {φ}_{0} \frac{ln ( {ρ}_{2} / {ρ}_{0} )}{ln ( λ / 2 a )} ,$$

where it can be assumed that long cylindrical electrode arms 26, 29, 32, 35, 38, 41, 44, 47 are those whose radii a are small compared with their separation λ/2. This result can follow from the potential of two parallel infinite line charges with opposite uniform linear charge densities. The potential produced by electrodes Φ₁ 59 and Φ₃ 56 can be similar, as expressed in the following equation:

$$φ = {φ}_{1} \frac{ln ( {ρ}_{3} / {ρ}_{1} )}{ln ( λ / 2 a )} .$$

A linear superposition of the previous equations can be employed to write the potential at position r (x, z) and time t produced by an electrode pattern extending indefinitely in the ±x directions, as expressed by the corresponding electric potential of:

$$φ ( r , t ) = \frac{{φ}_{0} ( t )}{ln ( λ / 2 a )} {\sum }_{l , m = - ∞}^{∞} ln \frac{\vert r - {r}_{2}^{( l , m )} \vert}{\vert r - {r}_{0}^{( l , m )} \vert} + \frac{{φ}_{1} ( t )}{ln ( λ / 2 a )} {\sum }_{l , m = - ∞}^{∞} ln \frac{\vert r - {r}_{3}^{( l , m )} \vert}{\vert r - {r}_{1}^{( l , m )} \vert}$$

$$where , \\ \begin{matrix}{r}_{0}^{( l , m )} = ( l λ , h + 2 mh ) \\ {r}_{1}^{( l , m )} = ( λ / 1 + l λ , 2 mh ) \\ {r}_{2}^{( l , m )} = ( λ / 2 + l λ , h + 2 mh ) \\ {r}_{3}^{( l , m )} = ( 3 λ / 4 + l λ , 2 mh )\end{matrix}$$

can be the position vectors of electrode arms 26, 29, 32, 35, 38, 41, 44, 47, with an integer l designating the particular wavelength of the electrode pattern. In these equations, the integer m designates the image charges needed to ensure that the model correctly describes the insulating surfaces at the top and the bottom of the channel. The electric potential can be valid, except near the sidewalls of channel 11 whose widths w are large compared with their heights h, since it ignores any variations in the y (cross-channel) direction and considers electrode arms 26, 29, 32, 35, 38, 41, 44, 47 to be indefinitely long. In fact, such wider channels can be advantageous because the wide channels can ensure similar behavior for all particles that remain sufficiently far from the sidewalls of the device 10. The corresponding electric field is expressed in:

$$E ( r , t ) = \frac{{φ}_{0} ( t )}{ln ( λ / 2 a )} {\sum }_{l , m = - ∞}^{∞} ( \begin{matrix}\frac{r - {r}_{0}^{( l , m )}}{{\vert r - {r}_{0}^{( l , m )} \vert}^{2}} - \\ \frac{r - {r}_{2}^{( l , m )}}{{\vert r - {r}_{2}^{( l , m )} \vert}^{2}}\end{matrix} ) + \frac{{φ}_{1} ( t )}{ln ( λ / 2 a )} {\sum }_{l , m = - ∞}^{∞} ( \begin{matrix}\frac{r - {r}_{1}^{( l , m )}}{{\vert r - {r}_{1}^{( l , m )} \vert}^{2}} - \\ \frac{r - {r}_{3}^{( l , m )}}{{\vert r - {r}_{3}^{( l , m )} \vert}^{2}}\end{matrix} )$$

A preference of channel height h can be shown where λ=80 μm, f=2 Hz, a=1 μm, Φ=0.5 V, V=0 and μ=0.2 cm²/kV−s. In embodiments of the electrophoresis device 10 wherein the channel height h is twenty micrometers and ten micrometers, respectively, particles can be incompletely entrained by the continuous periodic electric wave and can occasionally retrogress in their forward motion, and can also occasionally contact the z=0 and z=h boundaries when the channel height h equals ten micrometers. In addition, the efficiency of the electrophoresis device 10 is enhanced because a channel height h between twenty micrometers and ten micrometers suppresses turbulence and mixing within channel 11.

In an embodiment of the electrophoresis device 10 where the channel height h is fifteen micrometers, the particles can be fully entrained by the continuous periodic electric wave and can move forward by one electrode arm 26, 29, 32, 35, 38, 41, 44, 47 (a horizontal distance λ/4) during each quarter period τ/4, and can have an average velocity of ūₓ=c=fλ=160 μm/s. By using λ=80 μm, f=2 Hz, a=1 μm, Φ=0.8 V, and V=0, the average velocities of particles of different mobilities can be analyzed. Particle trajectories can be integrated over a time t≧500τ, where τ is the wave period, and can be used to determine the average velocity from 0ₓ=(x_{f}−xᵢ)/t where x_{f} and xᵢ are the initial and final positions of the particles along the x axis. Using these parameters, low-mobility particles with μ<μ_{c}=0.04046 cm²/kV−s can be bound to nearby electrode arms 26, 29, 32, 35, 38, 41, 44, 47. These particles can oscillate about electrode arms 26, 29, 32, 35, 38, 41, 44, 47 without making any net forward progress along channel 11, whence ūₓ0. A transition to finite ūₓ at a critical mobility μ_{c} can be quite abrupt, in contrast with a softer transition to full entrainment (ūₓ=c) at μ=μ0=0.0845 cm²/kV−s.

In an embodiment of the electrophoresis device 10 where ūₓ is a smooth monotonically increasing function between ū_{c} and n̅₀, regions of periodic behavior can be found. Above μ₀, particles can be fully entrained by the continuous periodic electric wave, moving forward by one electrode arm 26, 29, 32, 35, 38, 41, 44, 47 during each quarter period τ/4, with an average velocity ūₓ=c. Just above μ₀, particles can require an additional full period τ to travel to the next electrode arm 26, 29, 32, 35, 38, 41, 44, 47 taking a time 5τ/4 with an average velocity of ūₓ=c/5. Just above μ₂, particles can take a time 9τ/4 to travel to the next electrode arm 26, 29, 32, 35, 38, 41, 44, 47, requiring two additional full periods, and can travel with an average velocity of ūₓ=c/9. Just above μ₃, particles can take a time 13τ/4 to travel to the next electrode arm 26, 29, 32, 35, 38, 41, 44, 47, requiring three additional full periods, and can travel with an average velocity of ūₓ=c/13. Thus, these values can show regions of periodic behavior with dimensionless periods of one, five, nine and thirteen. The μ₀ can be defined specifically to be the smallest mobilities for which ūₓ is within 2% of the equation:

$${\overline{u}}_{x} = \frac{c}{1 + 4 n} ,$$

for n=0, 1, 2, . . . , where (n+¼)τ can be the time required by a particle to reach the next electrode arm 26, 29, 32, 35, 38, 41, 44, 47.

The scaling properties of equations of motion can allow for a general expression of the dependence of the critical mobility on the frequency f wavelength λ, and electric potential amplitude Φ, as expressed in the equation:

$$r = \frac{μΦ}{f {λ}^{2}}$$

The dimensionless constant 0.2529, determined from the value μ_{c}=0.04046 cm²kV−s for h=15 μm, λ=80 μm, f=2 Hz, a=1 μm, and Φ=0.8 V, can apply generally for V=0 as long as λ/h=16/3 and h/a=15. In a similar way, estimates of general threshold mobilities μₙ/μ_{c}=2.09, 1.75, 1.25, and 1.09 for n=0, 1, 2, and 3 can be obtained. These mobilities can be less precisely known than μ_{c} because the associated transitions can be less sharp.

The equations μ₀=2.09μ_{c} and the previous equation can be used to tune the electrophoresis device 10 to the mobilities of the particles to be separated, design multi-dimensional separation devices, or vary the frequency or direction of the continuous periodic electric wave during an electrophoretic separation process in order to separate particles of different mobilities. In such instances, a mobility factor of only 2.09 can separate fully entrained particles from bound particles. Additionally, ūₓ≦0.2c for particles with mobilities μ<2μ_{c} and ūₓ can increase five-fold to c within the narrow range 2μ_{c}=2.09μ_{c}. Thus, if average velocities less than 0.2c can be ignored, then ūₓ can effectively be treated as a step function with ūₓ≈0 for μ<2μ_{c} and ūₓ≈c for μ>2μ_{c}.

In one embodiment of the electrophoresis device 10, the channel height h can be fourteen micrometers while holding all other parameters at the values quoted above. A channel height h of fourteen micrometers can raise the critical mobility to μ_{c}=0.04060 cm²/kV−s and can lower the entrainment threshold to μ₀=0.081 cm²/kV−s, but can destroy full entrainment for μ>0.09 cm²/kV−s, where ūₓ≈0.5c. In an embodiment of the electrophoresis device 10 where the channel height h is sixteen micrometers, the critical mobility can be lowered to μ_{c}=0.04023 cm²/kV−s and can raise the entrainment threshold to μ₀=0.0885 cm²kV−s, but may not destroy full entrainment for μ>μ₀. Thus, although the mobility factor separating fully entrained particles from bound particles can increase 2.20 for a channel height h of sixteen micrometers, the basic behavior of the electrophoretic separation can appear to be similar to the behavior for a channel height h of fifteen micrometers.

What has been described above includes exemplary embodiments of a continuous periodic electric wave electrophoresis device and method. It is, of course, not possible to describe every conceivable combination of components or methodologies for purposes of this description, but one of ordinary skill in the art may recognize that further combinations and permutations are possible in light of the overall teaching of this disclosure. Accordingly, the description provided herein is intended to be illustrative only, and should be considered to embrace any and all alterations, modifications, and/or variations that fall within the spirit and scope of the appended claims.

What is claimed is:

1. An electrophoresis device, comprising:
(a) a top surface;
(b) a bottom surface;
(c) a pair of spaced apart spacers disposed between said top and bottom surfaces defining a channel therebetween; and
(d) at least three interdigitated arrays of conducting electrodes positioned adjacent said channel.

2. The electrophoresis device of claim 1 wherein each said interdigitated array of conducting electrodes has an individually controllable electric potential.

3. The electrophoresis device of claim 1 wherein said top and bottom surfaces and said spacers are substantially non-electrically conducting.

4. The electrophoresis device of claim 1 wherein said channel is defined by the width and height of said spacers.

5. The electrophoresis device of claim 1 wherein at least two of said at least three interdigitated arrays of conducting electrodes are positioned on a different side of said channel from another of said at least three interdigitated arrays of conducting electrodes.

6. The electrophoresis device of claim 1 further comprising two interdigitated arrays of conducting electrodes positioned adjacent a first side of said channel and two interdigitated arrays of conducting electrodes positioned adjacent a second side of said channel.

7. The electrophoresis device of claim 6 wherein said first side is opposite said second side.

8. The electrophoresis device of claim 1 wherein said interdigitated array of conducting electrodes is adapted to be connected to a controllable source of electricity to create a continuous periodic electric wave within said channel.

9. The electrophoresis device of claim 2 wherein each said electric potential is independently controllable to create a continuous periodic electric wave having a selectable wave speed within said channel such that particles having an electrophoretic velocity greater than or substantially equal to said wave speed are entrained by said continuous periodic electric wave.

10. The electrophoresis device of claim 9 wherein said continuous periodic electric wave substantially immobilizes particles having an electrophoretic velocity less than said wave speed.

11. The electrophoresis device of claim 1 further comprising:
(a) a plurality of said channels;
(b) a plurality of sets of said at least three interdigitated arrays of conducting electrodes;
(c) each said set being individually controllable and positioned adjacent one of said plurality of channels; and
(d) wherein multidimensional separation is enabled such that particles of different electrophoretic velocities can be separated into different ones of said plurality of channels.

12. An electrophoresis device, comprising:
(a) a channel provided through a block; and
(b) at least three interdigitated arrays of conducting electrodes positioned adjacent said channel.

13. The electrophoresis device of claim 12 wherein each said interdigitated array of conducting electrodes has an individually controllable electric potential.

14. The electrophoresis device of claim 12 wherein said block is substantially non-electrically conducting.

15. The electrophoresis device of claim 13 wherein each said electric potential is adapted to be connected to a controllable source of electricity to create a continuous periodic electric wave within said channel.

16. The electrophoresis device of claim 12 wherein at least two of said at least three interdigitated arrays of conducting electrodes are positioned on a different side of said channel from another of said at least three interdigitated arrays of conducting electrodes.

17. The electrophoresis device of claim 12 further comprising two interdigitated arrays of conducting electrodes positioned adjacent a first side of said channel and two interdigitated arrays of conducting electrodes positioned adjacent a second side of said channel.

18. The electrophoresis device of claim 12 wherein said channel is generally cylindrical shaped and said interdigitated arrays of conducting electrodes are arcuate shaped.

19. The electrophoresis device of claim 13 wherein each said electric potential is independently controllable to create a continuous periodic electric wave having a selectable wave speed within said channel such that particles having an electrophoretic velocity greater than or substantially equal to said wave speed are entrained by said continuous periodic electric wave.

20. The electrophoresis device of claim 13 wherein said continuous periodic electric wave substantially immobilizes particles having an electrophoretic velocity less than said wave speed.

21. The electrophoresis device of claim 12 further comprising:
(a) a plurality of said channels;
(b) a plurality of sets of said at least three interdigitated arrays of conducting electrodes;
(c) each said set being individually controllable and positioned adjacent one of said plurality of channels; and
(d) wherein multidimensional separation is enabled such that particles of different electrophoretic velocities can be separated into different ones of said plurality of channels.

22. An electrophoresis method comprising:
(a) providing a sample containing charged particles to be separated within a channel; and
(b) creating a continuous periodic electric wave in said channel, said continuous periodic electric wave having a wave speed such that particles having an electrophoretic velocity greater than or substantially equal to said wave speed are entrained.

23. The electrophoretic particle separation process of claim 22 wherein particles having an electrophoretic velocity less than said wave speed are substantially immobilized.

24. The electrophoretic particle separation process of claim 22 wherein said sample containing particles to be separated further comprises fully functional, non-denatured proteins.

25. The electrophoretic particle separation process of claim 22 wherein said sample containing particles to be separated further comprises a buffer solution.

26. The electrophoretic particle separation process of claim 22 wherein said sample containing particles to be separated further comprises a detergent.

27. The electrophoretic particle separation process of claim 25 further comprising:
(a) a plurality of said channels in fluid communication;
(b) creating a continous periodic elective wave in at least one of said plurality of channels;
(c) wherein multidimensional separation is enabled such that particles of different electrophoretic velocities are separated into different ones of said plurality of channels.

28. The electrophoretic particle separation process of claim 22 further comprising imposing a pressure driven flow to enhance the effects of said continuous periodic electric wave.

29. The electrophoretic particle separation process of claim 22 further comprising imposing an electro-osmotic flow to enhance the effects of said continuous periodic electric wave.

30. The electrophoretic particle separation process of claim 29 further comprising imposing an oscillating electric field to suppress said electro-osmotic flow.
